(19) United States
(12) Patent Application Publication
(10) Pub. No.: US 2008/0065776 A1
(43) Pub. Date: Mar. 13, 2008

(54) METHOD OF CONNECTING A FIRST DEVICE AND A SECOND DEVICE

(75) Inventors: Seamus Moloney, Riihimaki (FI); Nadarajah Asokan, Espoo (FI); Kari Ti Kostiainen, Helsinki (FI); Jose Costa-Requena, Helsinki (FI)

Correspondence Address: G. peter Albert Jr.;Foley & Lardner LLP, P.O. Box 80278, San Diego, CA, 92138-0278, US

(73) Assignee: Nokia Corporation

(21) Appl. No.: 11/779,740

(22) Filed: Jul. 18, 2007

Related U.S. Application Data
(60) Provisional application No. 60/836,178, filed on Aug. 7, 2006.

(51) Int. Cl. G06F 15/16

(52) U.S. Cl. 709/229

(57) ABSTRACT

A method for connecting a first device and a second device. The method comprises associating at a third party temporary unique information with information associated with said first device; receiving from said third party said unique information at said first device; inputting said unique information to said second device; sending said unique information from said second device to said third party; and receiving from said third party at said second device said associated information.

### CROSS-REFERENCE TO RELATED PATENT APPLICATIONS

The present application claims priority to U.S. Provisional Patent Application No. 60/836,178, filed Aug. 7, 2006.

### FIELD OF THE INVENTION

The present invention relates to a method for connecting a first device and a second device, using a third party.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Creating a secure connection between two devices with no prior security context, such as a shared key, is a known problem. Authenticated key establishment using a remote server is known. Examples include systems with a key distribution server, like Kerberos), and systems based on a public key infrastructure. In these systems, the remote server is trusted to correctly verify the identities of the parties involved in the key establishment. However, this has a problem if there is no fully trusted server which could identify the identities of the parties involved in the key establishment.

Human-assisted key establishment is known in the context of proximity radios. This is used when two devices can reliably find each other and establish direct communication (e.g. both are in the same local network) with one another. In the recently standardized Improved Bluetooth Pairing, the user authenticates the key agreement e.g. by comparing a short numeric value that is shown on both of the devices. In recently standardized WiFi Protected Setup, the user can authenticate the key agreement e.g. by reading a short PIN (personal identity number) code from one device and entering it into the other. Both of these solutions utilize the fact that devices are in physical proximity to each other. However this method is disadvantageous in the situation when the devices cannot easily find each other because the human user has to either know the address of one device and type it into the other device or choose the right device from a long list of possible meaningless device names.

Additionally, not all devices have proximity radios. For many devices, Internet connectivity is the only common bearer. In the following scenario, a remote access device (RAD), such as mobile phone, needs to establish a secure connection to a home device, e.g. home gateway or PC server (HPCS). Home PCs typically do not have proximity radio interfaces so the key agreement between the RAD and HPCS cannot be done using the new proximity radio security setup schemes even though the devices are in physical proximity to each other at home.

Applying the protocols used in the Improved Bluetooth Pairing and WiFi Protected Setup over the Internet bearer is not user-friendly, since the user would have to know the address of one device and type it in to the other device manually.

It is an aim of some embodiments to address or at least mitigate one or more of the above described problems.

### SUMMARY OF THE INVENTION

According to one aspect of the present invention, there is provided a method for connecting a first device and a second device, said method comprising associating at a third party temporary unique information with information associated with said first device; receiving from said third party said unique information at said first device; inputting said unique information to said second device; sending said unique information from said second device to said third party; and receiving from said third party at said second device said associated information.

According to another aspect of the present invention, there is provided a system comprising a first device; a second device; and a third party; wherein first device is configured to obtain from said third party a temporary unique identifier, said third party is configured to store said temporary unique identifier in association with information related to said first device, said first device is configured to communicate said temporary unique identifier to a user, said second device is configured to have an input to receive from said user said temporary unique identifier and said second device is configured to receive from said third party said information related to said user.

According to another aspect of the present invention, there is provided a first device, said first device comprising means for sending information associated with said first device to a third party; means for receiving temporary unique information from said third party; means for providing said temporary unique information to a user; and means for establishing a secure connection with a second device, on the basis of said temporary unique information, said first and second devices being connected to one another via at least one other entity.

According to another aspect of the present invention, there is provided a first device, said first device comprising a transmitter arranged to transmit information associated with said first device to a third party; a receiver arranged to receive said temporary unique information from said third party; a user interface arranged to provide said temporary unique information to a user; and a processor for permitting the establishment of a secure connection with a second device, on the basis of said temporary unique information, said first and second devices being connected to one another via at least one other entity.

According to another aspect of the present invention, there is provided a second device, said second device comprising means for inputting temporary unique information associated with a first device to which said second device is to be connected; means for sending said temporary unique information to a third party; and means for receiving from said third party information associated with said first device, said associated information permitting the second device to connect to said first device.

According to another aspect of the present invention, there is provided a second device, said second device comprising a user interface arranged so that a user can input temporary information associated with a first device to which said second device is to be connected; a transmitter arranged to send said temporary unique information to a third party; and a receiver arranged to receive from said third party information associated with said first device, said associated information permitting the second device to connect to said first device.

According to another aspect of the present invention, there is provided a third party, said third party comprising means for selecting a temporary unique identifier to be associated with a first device; means for storing an association between said temporary unique identifier and information related to said first device; means for sending said temporary unique identifier to said first device; means for receiving said temporary unique identifier from said second device; and means for sending said information related to said first device to said second device.

According to another aspect of the present invention, there is provided a third party, said third party comprising a processor arranged to select a temporary unique identifier to be associated with a first device; a memory arranged to store an association between said temporary unique identifier and information related to said first device; a transmitter arranged to send said temporary unique identifier to said first device and said information related to said first device to said second device; and a receiver arranged to receive said temporary unique identifier from said second device.

According to another aspect of the present invention, there is provided a computer program for use on a first device comprising computer readable program portions, the computer-readable program code portion comprising a first executable portion for causing information associated with said first device to be sent to a third party; a second executable portion for receiving temporary unique information from said third party; a third executable portion for causing said temporary unique information to be provided to a user; and a fourth executable portion for causing a secure connection to be established with a second device, on the basis of said temporary unique information, said first and second devices being connected to one another via at least one other entity.

According to another aspect of the present invention, there is provided a computer program for use on a second device comprising computer readable program portions, the computer-readable program code portion comprising a first executable portion for receiving temporary unique information associated with a first device to which said second device is to be connected; a second executable portion for causing said temporary unique information to be sent to a third party; and a third executable portion configured to receive from said third party information associated with said first device, said associated information permitting the second device to connect to said first device.

According to another aspect of the present invention, there is provided a computer program for use on a third party comprising computer readable program portions, the computer-readable program code portion comprising a first executable portion for selecting a temporary unique identifier to be associated with a first device; a second executable portion for causing an association between said temporary unique identifier and information related to said first device to be stored; a third executable portion for causing said temporary unique identifier to be sent to said first device; a fourth executable portion for receiving said temporary unique identifier from said second device; and a fifth executable portion for causing said information related to said first device to said second device.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

For a better understanding of the present invention and as to how the same may be carried into effect, reference will now be made by way of example only to the accompanying drawings in which:

FIG. 1 shows schematically a system in which embodiments of the present invention can be implemented;

FIG. 2 shows schematically a signal flow in a first phase of an embodiment of the invention;

FIG. 3 shows schematically a first signal flow in a second phase of an embodiment of the invention;

FIG. 4 shows schematically a home device e.g. PC server (HPCS) embodying the present invention;

FIG. 5 shows schematically a remote access device (RAD) embodying the present invention; and

FIG. 6 shows schematically a remote access server (RAS) embodying the present invention.

### DETAILED DESCRIPTION OF VARIOUS EMBODIMENTS

In preferred embodiments of the invention, one or more of the following are carried out:

1. Creating a secure connection between two devices. In the examples discussed in more detail hereinafter the two devices are described as being a RAD and a home device such as a PC server. However, this is by way of example only and the device can take any suitable form.

2. A 3^{rd} party, preferably, but not necessarily, trusted device is used that will act as proxy for the security binding between the RAD and the home device. This binding uses a queue number which is described in more detail hereinafter. The 3^{rd} party may not apriori know either device. As mentioned the 3^{rd} party does not need to be trusted but if the 3^{rd} party is trusted by one of the devices, the procedure may be simpler. In this latter case, the 3^{rd} party does not need to be trusted by the other device.

3. Generating of the required security credentials out of the binding process to set up the security connection between the RAD and the home device. These credentials may comprise both shared secrets stored in the RAD and home device or standard certificates (i.e. X.509 or device certificate profile from ITU-T J.192 can be used for home gateway authentication, code authentication, and service provider authentication). The certificates allow the use of standard protocols e.g. TLS or IPSec for the connection between the connection between the two devices.

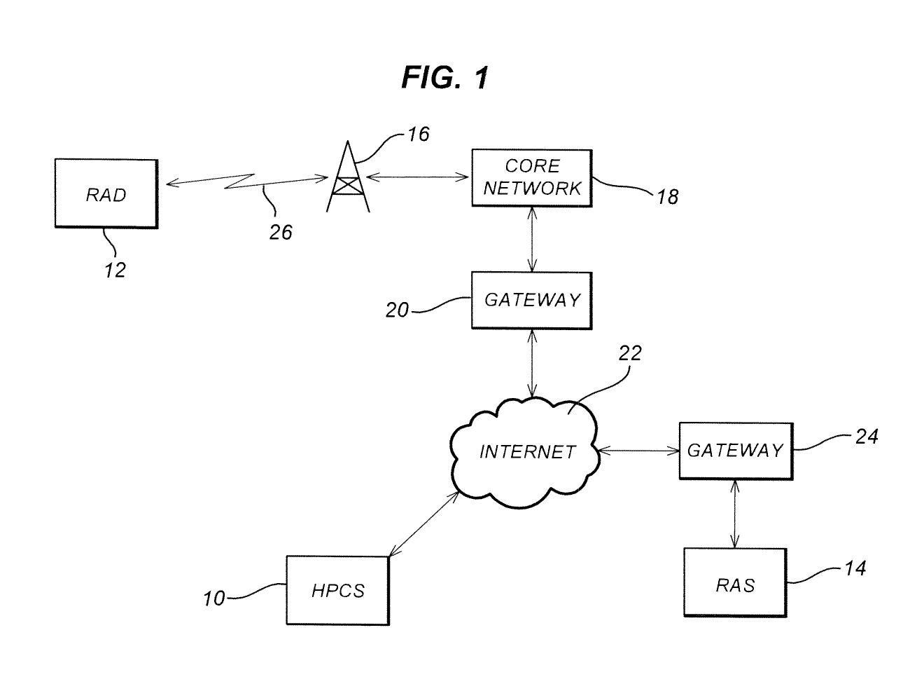

Reference is made first to FIG. 1 which shows schematically a system in which embodiments of the present invention can be implemented. A RAD 12 is arranged to communicate via a wireless connection 26 with a base station 16. The base station 16 is connected to a core network 18 of a communications system. A first gateway 20 is provided which permits the core network 18 to communicate with the Internet 20. The Internet 20 is connected to a HPCS 10. The Internet is also connected to a second gateway 24 which permits communication between the Internet and a RAS 14.

It should be appreciated that the arrangement shown in FIG. 1 is schematic and in practice there may be additional elements, not shown, present. In addition, the gateways are shown as separate entities. In some embodiments of the present invention, the gateway functionality may be incorporated into other entities such as for example the RAS 14. The HPCS 10 may include gateway functionality or be replaced by a gateway function in alternative embodiments of the invention.

The arrangement of FIG. 1 is such that the RAD is able to communicate with the HPCS and the RAS via the Internet, and vice versa. Further the RAS 14 and the HPCS 10 are able to communicate with one another via the Internet. In some embodiments of the invention, the HPCS 10 and the RAD 12 are in the same physical location or at least a user of the HPCS 10 and the RAD 12 has access to both of these devices.

The Internet is used herein as an example of a communication network providing connectivity between communication devices. The term Internet is used herein to denote a publicly accessible network of interconnected computer networks transmitting data using the Internet Protocol (IP). It shall be appreciated that embodiments of the invention are not limited to be performed using the Internet, but any network providing connectivity between devices may be suitable for embodiments of the invention.

Embodiments of the invention use a two phase approach to get two devices (HPCS and RAD) connected securely. In the first phase, the Remote Access Server RAS helps the user in getting the intended two devices connected: First the HPCS connects to the RAS which assigns a short queue number (QN) to the HPCS. The HPCS shows the QN to the user who then types the QN into the RAD which can then fetch the public key and address of HPCS from RAS and then connect directly to HPCS using this public key and address.

In the described embodiment, the PC is the one doing the transactions and the RAD will connect with the PC. However, it is of course possible that the RAD does the transactions and the PC will connect to the RAD.

In the second phase, once the HPCS and RAD are connected, a mutual authentication between the HPCS and RAD should be achieved or completed. In an embodiment, a key agreement is carried out and authenticated using, for example, a known human-assisted key agreement protocol. This second part completes the establishment of the secure connection between HPCS and RAD.

This method applies regardless of the level of trust on RAS. If RAS is trusted, then the first phase actually authenticates the HPCS to the RAD. The second phase is for authenticating the RAD to the HPCS. If RAS is not trusted, then the first phase is just for the devices to find each other and communicate directly. The second phase achieves mutual authentication.

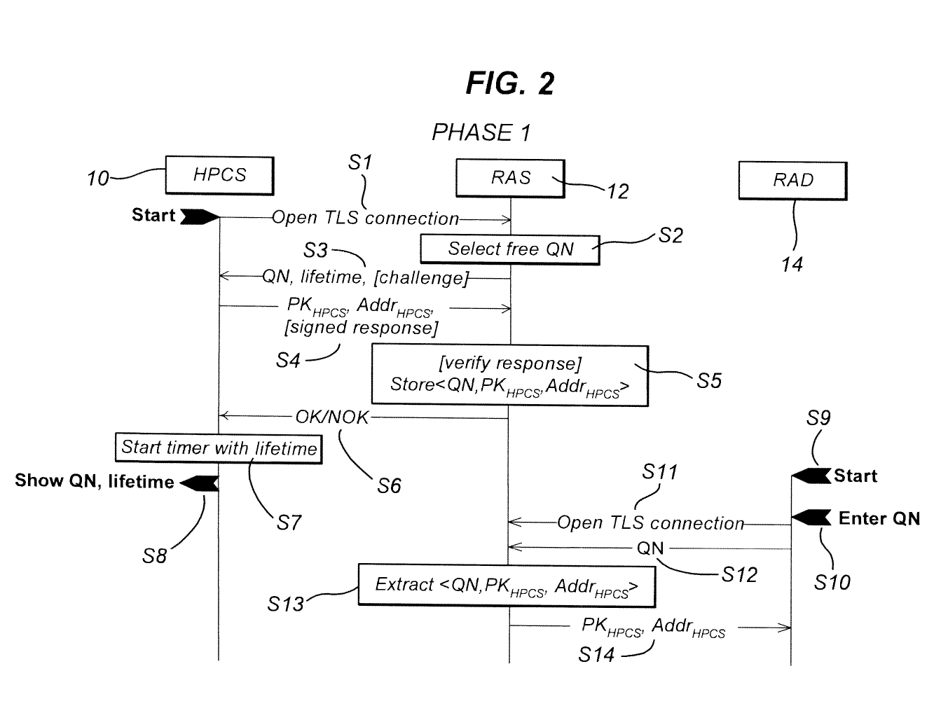

Reference is made to FIG. 2 which illustrates schematically the signal flow in the first phase in an embodiment of the present invention. In particular, FIG. 2 shows the signal flow between the HPCS 10 and the RAS 12 on the one hand and the signal flow between the RAD 14 and RAS 12 on the other hand. This may be via the other entities shown in FIG. 1 but for convenience these other entities are not shown.

The process is started in the HPCS 10. The user interacts with the HPCS 10 and in particular the software client runs on the HPCS 10. This software client is a dedicated software client which is aware of the URL (Uniform Resource Locator) for the RAS 12, which is located on the Internet. When the user starts the software client, a request for opening a connection is sent at S1 from the HPCS 10 to the URL of the RAS 14. The RAS 14 has a SSL (Secure Socket Layer) server certificate, which is issued by a certificate authority CA. The server certificate can be verified by client software on the RAD 12 and HPCS 10 so that at S1, the connection, which is opened between the HPCS 10 and RAS 12, is secure. The connection may be a TLS (Transport Layer Security) connection or IPSec tunnel.

At S2, the RAS 12 is arranged to select a short number. In this application, this short number will be referred to as a queue number (QN). The QN will be described in more detail hereinafter. The QN preferably will have the property that it is relatively short and will have a limited lifetime. The RAS 12 will have a number of QNs. The RAS will select a free QN, i.e. one which is not being used in another process.

At S3, the QN is sent from the RAS 12 to the HPCS 10. This is a response to the request sent by the HPCS 10 to the RAS 12 at S1. In one preferred embodiment of the invention, a challenge response mechanism is additionally used in this phase to protect from attackers potentially launching denial of service attacks against the RAS. Optionally, an indication of the lifetime of the queue number may also be provided to the HPCS 10 at S3.

At S4, once the HPCS 10 has received the QN, it makes a new request containing its public key. That public key can for example be a 2048 bit RSA (Rivest, Shamir and Adleman) public key PK_{HPCS}. At S4, this request is sent from the HPCS 10 to the RAS 12. The HPCS 10 will also include the address of the HPCS. If a challenge is included in the response received from the RAS 12, the HPCS 10 can provide the response to the challenge in this new request. However, this is optional. Thus, in summary, the HPCS 10 sends the PK_{HPCS}, the address of the HPCS and a signed response to the RAS 12 at S4.

At S5, the RAS 12 verifies the response received from the HPCS 10. The RAS 12 will also store the fact that there is a mapping between the QN, the public key of the HPCS 10 and the address of the HPCS. This is used as described later. At S6, the RAS 12 will send an acknowledgement message to the HPCS 10. This will effectively be an indication as to whether or not the method can proceed (an OK response) or whether there is some problem (a NOK, or not OK, response).

At S7, the HPCS will start a timer. The timer can take any suitable format. In an embodiment, it can be a countdown timer with the initial time being the lifetime of the QN. In an alternative, the timer may be a count up timer which expires when the lifetime value is reached. In one modification, a timer is started in the RAS and the entry in the RAS associated with the HPCS will be removed if the RAD does not register within a predetermined time period timed by the timer. The timer in the RAS may be in addition to or an alternative to the timer in the HPCS.

At S8, the QN is displayed or otherwise communicated by the HPCS 10 to the user. This indicates to the user that the user now needs to enter this QN to the RAD 14. It should be appreciated S7 and S8 can be in the opposite order or can take place generally at the same time.

S9 represents the start of the interaction with the RAD 14 by the user. This may, for example, comprise switching on the device if it is not already on. This also may comprise getting the RAD 14 into a mode in which the QN can be entered. At S10, the user will enter the QN to the RAD 14. Entering the QN to the RAD 14 can be done in any appropriate manner. Examples may comprise using a keyboard, a key pad, a joystick, a wheel, a touch screen, voice control, and so on.

At S11, the interaction of the user with the RAD 14 causes a secure connection, for example a TLS (transport layer security) connection, to be opened between the RAD 14 and RAS 12. This is effectively set up by a request sent at S11 from the RAD 14 to the RAS 12. This is similar to S1. At S12, the QN is sent from the RAD 14 to the RAS 12. In one modification to the invention, this can be included the request sent in S11. However, it is preferred that the secure connection be opened first and then the QN sent. It should be appreciated that S10 can be provided between S11 and S12 in one modification to the invention.

It should be appreciated that the user may be provided with a prompt in order to get them to enter the QN. The prompt can take any suitable form, such as a wording presented by means of a text or voice or other audio prompt. An example may be “please provide the identifier for your PC”.

In one modification to the invention, the QN can be sent at S12 with a challenge for the same reasons discussed in relation to S3. The RAS will then provide the response to the challenge in an appropriate message, for example that sent at S14.

In yet another modification, the RAS may send the challenge. This can take place at any suitable point, for example after S11 or S12. In one preferred modification, the challenge is sent in between S11 and S12. S12 will be modified so that the response from the RAD would include the QN as well as the response to the challenge.

At S13, the RAS 12 checks the QN received from the RAD 14. From the value of the QN, the RAS determines which public key and address information needs to be sent to the RAD. In other words, it determines the PK_{HPCS} and address of the HPCS associated with the QN received from the RAD. This information is sent at S14 to the RAD.

In one modification to arrangement shown in FIG. 2, the roles of the RAD and the HPCS can be reversed.

If RAS is trusted, the RAD knows that it has the public key of HPCS. However, the QN should preferably not be used for authenticating RAD to HPCS since QNs are preferably short and easy to handle, and thus an attacker may be able to guess one. So, in the second phase the HPCS authenticates the RAD and the RAD authenticates the HPCS if RAS is not trusted.

The term queue number is used in embodiments of the invention as an example. However, the identification code used for this purpose may also take another form of a sequence of characters, including numbers and/or other characters. The objective of this identification, or queue number, is to identify the device, such as HPCS, to the user in a simple manner, which is easy to handle when typing into the other device, such as the RAD. In a preferred embodiment, the identification is short.

In preferred embodiments of the present invention the queue number will have one or more of the following characteristics:

1. The RAS ensures that QNs are unique.

2. The QNs have limited lifetime (e.g., of the order of minutes for example between 30 seconds and 5 minutes. In one embodiment the lifetime may be of the order of 30 seconds to 2 minutes and preferably 1 min.).

3. The RAS will allow sufficient time before reusing a value QN (the reuse value may be of the order of 5 to 20 times the lifetime, more preferably between 7 and 15 times the lifetime and in one embodiment 10 times the lifetime).

4. The QN size (in digits) depends on expected number of HPCS connections:

100 connections/minute lead to requirement for a 3 digit QN. The queue size can be of any suitable size but is preferably relatively short. For example, the QN may be no longer than 10 digits or characters, and is more preferably less than 8 characters. Preferred embodiments of the invention have a QN which is 3 or 4 digits. In one modification, the queue number comprises words. This makes the uses of the queue number easier for the user,

5. The QN Lifetime can be adjusted dynamically depending on load on RAS

6. The QN is a number but in alternative embodiments of the invention can be characters or symbols or a mixture of characters and/or numbers and/or symbols.

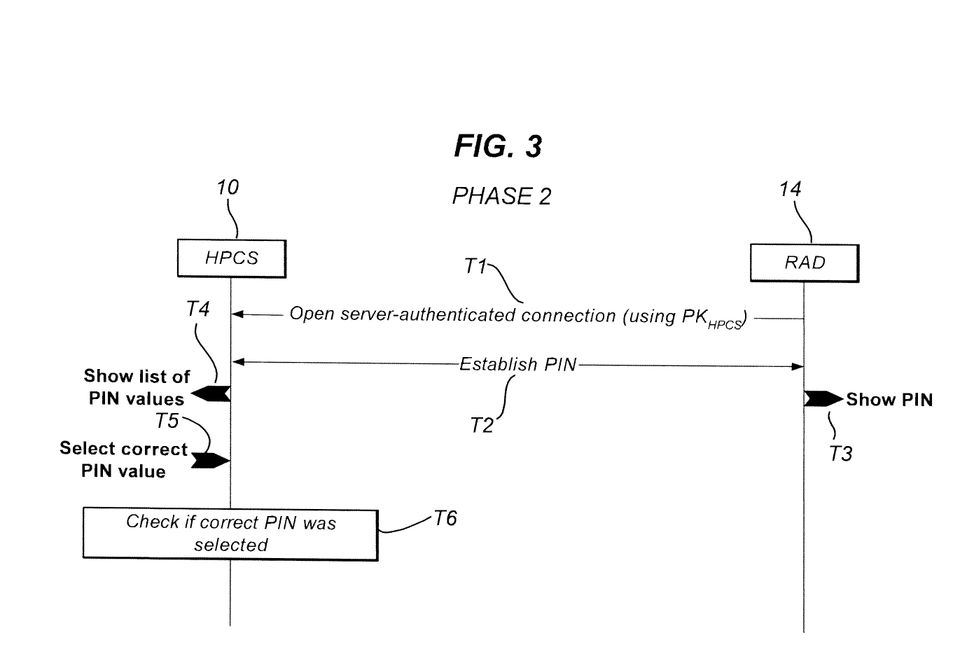

Reference is made to FIG. 3 which shows the signalling which can take place after the signalling shown in FIG. 2 has been completed.

Once the signalling of FIG. 2 has been completed, the RAD knows the public key and address of the HPCS and can therefore connect to the HPCS directly. Accordingly, the HPCS and RAD do not need to communicate via the RAS.

If the RAS is trusted, the RAD knows that it has the public key of HPCS. The QN is preferably not used for authenticating the RAD to HPCS since the QNs are short which makes it potential easier for an attacker to guess the QN. Thus, in the signalling shown in FIG. 3, the HPCS needs to authenticate the RAD and the RAD has to authenticate the HPCS if the RAS is not trusted. FIG. 3 shows one way to achieve mutual authentication.

At T1, the RAD 14 uses the public key PK_{HPCS} it obtained during the signalling described in relation to FIG. 2 and uses this to establish a protected connection, such as a TLS tunnel, to the HPCS 10. This involves a request being sent from the RAD 14 to the HPCS 10.

At T2, the HPCS 10 and RAD 14 agree on an identification sequence. The identification sequence may be a PIN (Personal Identification Number), as shown in FIG. 3. The PIN may be chosen by either party and sent to the other party via the protected connection. The PIN may be a random number selected by one of the parties.

At T3, the RAD 14 displays or otherwise communicates the identification sequence to the user. At T4, the HPCS may show a list of possible identification sequences. It should be appreciated that T3 and T4 can take place more or less at the same time. It should be appreciated that T3 could instead be performed by the HPCS and T4 could be performed by the RAD. In one modification, T3 and T4 are performed as shown in FIG. 3 and additionally the T3 is additionally performed by the HPCS and T4 is additionally performed by the RAD.

At T5, the user inputs the identification sequence shown on the RAD 14 to the HPCS 14. If the list of possible identification sequences is shown, the user may select the correct identification sequence from the list. At T6, the HPCS 10 checks to see if the identification sequence selected is the correct identification sequence. If it is correct, then the communication between the HPCS and RAD continues. Otherwise, the procedure is aborted.

It should be appreciated that that showing the list of identification sequences in T4 can be omitted and the user may simply enter in the identification to the HPCS, possibly in response to a prompt message. The PIN is used herein as an example of an identification sequence, but other suitable identifiers may also be used.

At this point, both RAD and HPCS can trust that the protected connection they have is really with each other. They can now agree on credentials (such as a username and a long password) using which the RAD can subsequently connect to HPCS securely.

If the RAS is trusted, then the protected connection established in T1 is a server-authenticated connection. If the RAS is not trusted or if it is not possible to establish a server authenticated connection to HPCS described above, then the RAD would make an unauthenticated connection to the HPCS in T1. In this case, “establishing a PIN” (T2) is replaced by the following: HPCS and RAD run a mutual authentication procedure, such as a “short authentication string protocol” described in eprint.iacr.org/2005/424. In this procedure, after exchanging some information, both HPCS and RAD independently calculate a short checksum (e.g., 4 digits). The user then compares the two checksums. If the strings are the same, then mutual authentication is achieved. Comparison of the checksum can be done in several ways. One way is similar to the PIN entry case: RAD displays its checksum and prompts for acceptance; HPCS shows a list of candidate checksums (including the correct checksum it expects) from which the user is asked to pick the correct one. If the user picks the expected checksum, HPCS indicates success and asks the user to accept RAD's prompt as well.

Known mechanisms for countering spamming or denial of service can be used in conjunction with the above described embodiments. One way is to use the standard “proof-of-work” type trick. Challenge/response could be used for this: Whenever someone (HPCS or RAD) connects to RAS, it sends back a challenge (challenge will remain the same for some time). The responder has to then send back a response such that: hash(response|challenge|responder_address|maybe-some-other-known-string) should produce a hash such that the first x number of bits is 0. The theory is that, the responder can only find this response by brute force, and it will cost him some time (depending on x, which can be adjusted depending on the severity of attack). The RAS can easily verify whether a response is valid. Legitimate HPCS users will not notice much of a difference, but an attacker using a single machine cannot bombard RAS and so cause denial of service. Another standard way is to use CAPTCHAs (completely automated public Turing test to tell computers and humans apart) to ensure that the client connecting to RAS has a human user behind it.

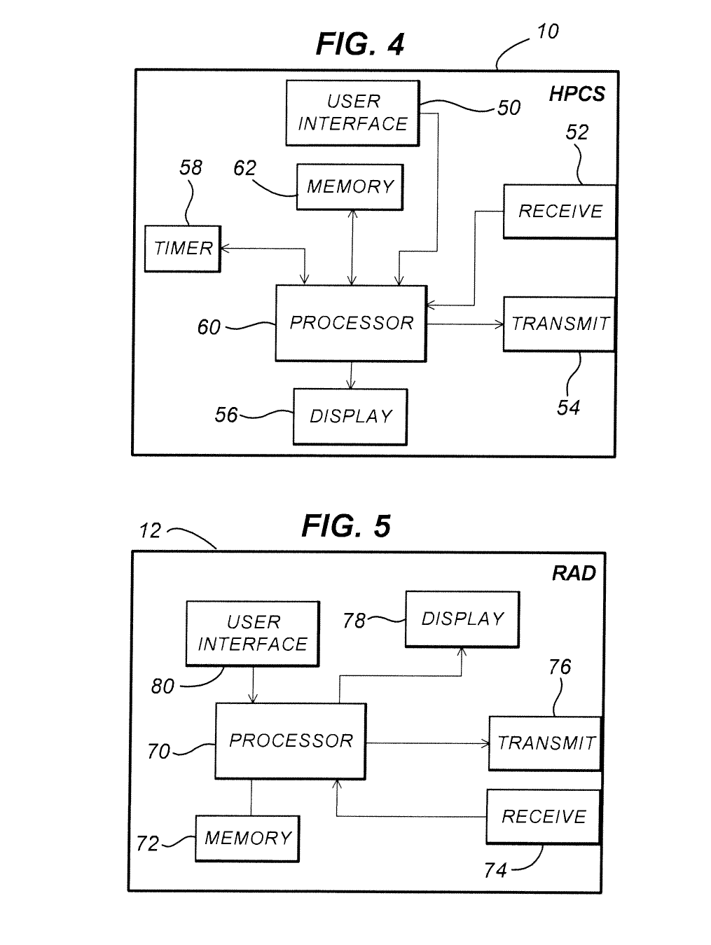

Reference is now made to FIG. 4 which schematically shows the HPCS 10. The HPCS 10 has a user interface 50 which allows the user to start the process and enter or select identification sequences such as PIN numbers. A display 56 is provided for displaying the QN and the lifetime. A receive circuit 52 is provided for receiving information from either the RAD or the RAS as described in relation to FIGS. 2 and 3. Likewise a transmit circuit is provided for transmitting information to the RAD or RAS as described in relation to FIGS. 2 and 3. The receive and transmit circuitry may be combined in some embodiments. The receive and transmit circuits may be arranged to operate via wired or wireless connections. The receive circuit 52 is arranged to pass the received information to the processor 60 which controls what information is transmitted by the transmit circuit 54. The processor 60 controls the display 56 and receives the information input via the user interface 50.

A memory 62 is provided for storing information such as QN, the lifetime of the QN, the public key of the device and its address. The memory can take any suitable form. The memory 62 is written to and read by the processor 60. A timer 58 is provided which is able to start the count down of S7. The timer is controlled by the processor. In the event that the connection between the HPCS and the RAD is not established before the timer has expired, the connection will be aborted.

Reference is now made to FIG. 5 which schematically shows RAD 12. This has a processor 70 which is able to read data from and write data to a memory 72. The memory 72 is arranged to store information such at the public key and address of the HPCS and the QN. A display 78 controlled by the processor 70 is arranged to display a PIN or other identification sequences and prompt messages to ask the user to enter the QN. A user interface 80 is arranged to allow the user to input information such as the QN, and to allow the user to control the device. The information input via the user interface is processed by the processor. Transmit circuitry 76 is arranged to transmit the information discussed in relation to FIGS. 2 and 3. Receive circuitry 74 is arranged to receive the information discussed in relation to FIGS. 2 and 3. In some embodiments of the invention, the transmit and receive circuitry may be provided by common circuitry. This receive and transmit circuitry may be arranged to operated wirelessly or with a wired connection. It should be appreciated that in one modification, the functionality of both the RAD and the HPCS may be provided in one or both of these entities.

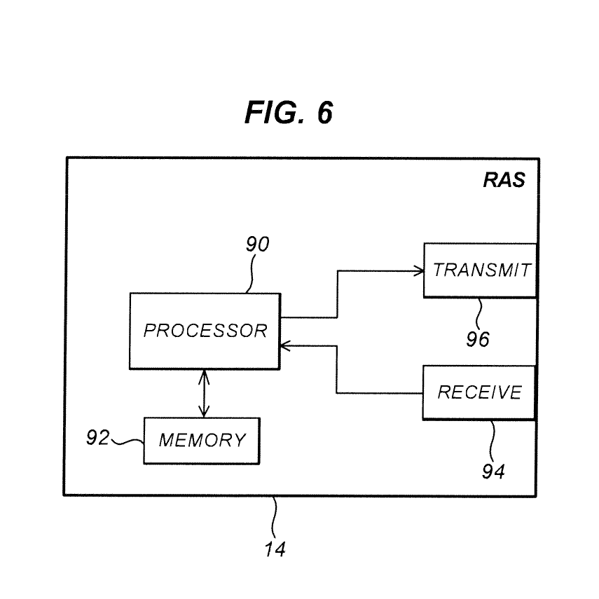

FIG. 6 shows schematically the RAS 14. The RAS has a processor 90 which is arranged to write to and read from a memory 92. The memory stores the association between the address of the HPCS, its public key and the associated QN. Transmit circuitry 96 is arranged to transmit the information discussed in relation to FIGS. 2 and 3. Receive circuitry 94 is arranged to receive the information discussed in relation to FIGS. 2 and 3. In some embodiments of the invention, the transmit and receive circuitry may be provided by common circuitry. This receive and transmit circuitry may be arranged to operated wirelessly or with a wired connection.

Compared to prior server-based authenticated key establishment solutions, embodiments of the invention are applicable even when the server is not fully trusted. Compared to prior serverless pairing methods, embodiments of the invention allow devices to find each other even when they are not on the same local network.

To illustrate the advantages of embodiments of the invention consider scenarios 1 and 2:

Scenario 1 HPCS picks an access code and sends it to RAS along with the credentials for subsequent access. HPCS shows the access code on the display. The user has to type the access code into RAD. RAD can retrieve the credentials from RAS by presenting the correct access code. To avoid accidental or malicious attacks, the access code must be sufficiently long.

Scenario 2 RAS is a dynamic DNS server and a CA trusted by RAD. HPCS registers a DNS name with RAS and receives a TLS server certificate. The user has to type in the same DNS name to RAD. Thereafter RAD can make a direct server-authenticated TLS connection to HPCS. Authenticating of the RAD still needs to be carried out.

By separating peer location (phase 1) and authentication (phase 2), embodiments of the invention are able to provide better usability without sacrificing security: the user has to type in a short code (e.g., 3 digits) into one device, and make a comparison of another short code (e.g., 4 digits). In contrast scenario 1 would require the user to type in longer strings (e.g., 10 digits). Scenario 2 would need the user to type in the DNS name of HPCS (e.g., several tens of characters) into RAD.

The above embodiments describe how a secure connection can be established between RAD and HPCS in a user-friendly manner using a partially trusted remote access server (RAS) which is available in the Internet to help in this establishment. However, it should be noted that this invention is not limited to the above mentioned remote access scenario only. This invention can be used as a general method of authenticated key agreement whenever a partially trusted server is available.

It should be appreciated that the two devices between which a connection is established could be any suitable devices, other than the RAD and HPCS. For example, the devices can be any two devices selected from a PC, a gateway or other device at home, gateway with user interface or input (e.g. keypad) capabilities, any remote access device, a Mobile telephone, mobile station, mobile communicator, personal digital assistant, portable computer, and data device. However, this list is not exhaustive.

In preferred embodiments of the invention, the two devices are able to communicate directly. However in alternative embodiments of the invention, the devices may not be able to communicate directly via wired or wireless connection. One or both of the devices may be wired devices. Alternatively or additionally one or both of the devices may be wireless devices.

According to one aspect of the present invention, the functions performed by one or more of the entities of the system, may be performed by various means, such as hardware and/or firmware, including those described above, alone and/or under control of a computer program product. The computer program product for performing one or more functions of embodiments of the present invention includes a computer-readable storage medium, such as the non-volatile storage medium, and software including computer-readable program code portions, such as a series of computer instructions, embodied in the computer-readable storage medium or downloadable into one or more of the entities used in embodiments of the invention.

It will be understood that each block or process of the control flow diagrams, and combinations of blocks or processes of the flow diagrams, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the control flow diagrams' block(s) or process(es). These computer program instructions may also be stored in a computer-readable memory that can direct a computer or other programmable apparatus to function in a particular manner, such that the instructions stored in the computer-readable memory produce an article of manufacture including instruction means which implement the function specified in the control flow diagrams' block(s) or process(es). The computer program instructions may also be loaded onto a computer or other programmable apparatus to cause a series of operational processes to be performed on the computer or other programmable apparatus to produce a computer-implemented process such that the instructions which execute on the computer or other programmable apparatus provide processes for implementing the functions specified in the control flow diagrams' block(s) or process(es).

Accordingly, blocks or processes of the control flow diagrams support combinations of means for performing the specified functions, combinations of processes for performing the specified functions and program instruction means for performing the specified functions. It will also be understood that one or more blocks or processes of the control flow diagrams, and combinations of blocks or processes in the control flow diagrams, can be implemented by special purpose hardware-based computer systems which perform the specified functions or processes, or combinations of special purpose hardware and computer instructions. The computer programs may be provided on one or more of the entities described in relation to the preferred embodiments of the invention.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for connecting a first device and a second device, comprising:
associating at a third party temporary unique information with information associated with the first device;
receiving from the third party the unique information at the first device;
inputting the unique information to the second device;
sending the unique information from the second device to the third party; and
receiving from the third party at the second device the associated information.

2. A method as claimed in claim 1, wherein the unique information is received over an internet from the third party at the first device.

3. A method as claimed in claim 1, wherein the unique information is sent over an internet from the second device to the third party.

4. A method as claimed in claim 1, wherein the temporary unique information has a limited lifetime.

5. A method as claimed in claim 4, wherein the temporary unique information has a limited lifetime of the order of 1 minute.

6. A method as claimed in claim 1, further comprising reusing the temporary unique information.

7. A method as claimed in claim 6, wherein the temporary unique information is reused only after at least a predetermined amount of time has lapsed.

8. A method as claimed in claim 7, wherein the temporary unique information is used only after at least a predetermined amount of time has lapsed, the predetermined amount of time being equal to ten times a length of time for which the temporary unique information is valid.

9. A method as claimed in claim 1, wherein the temporary unique information comprises at least three more digits.

10. A method as claimed in claim 1, wherein the temporary unique information has a limited lifetime, the limited lifetime being dependent on a load on the third party.

11. A method as claimed in claim 1, wherein the information associated with the first device comprises at least one of an address of the first device, an identity of the first device and a public key of the first device.

12. A method as claimed in claim 1, further comprising starting a timer at the first device when the temporary unique information is received.

13. A method as claimed in claim 9, further comprising determining if communication between the first and second device is established before the timer reaches a predetermined value and if not, aborting the method.

14. A method as claimed in claim 1, further comprising displaying the temporary unique identifier at the first device.

15. A method as claimed in claim 1, further comprising connecting the first device and the second device.

16. A method as claimed in claim 15, further comprising having at least one of the first and second devices authenticate the connection to the other of the first and second devices.

17. A method as claimed in claim 16, wherein the authenticating occurs with human-assistance.

18. A method as claimed in claim 17, further comprising:
agreeing on an identification sequence in the first and second devices;
with human assistance, obtaining the identification sequence from one of the first and second devices; and
inputting the identification sequence into the other of the first and second devices.

19. A method as claimed in claim 18, wherein the agreeing of the identification sequence by one of the first and second devices providing the identification sequence to the other of the first and second devices occurs via a secure connection therebetween.

20. A method as claimed in claim 15, further comprising generating security credentials to set up a secure connection between the first and second device.

21. A method as claimed in claim 20, wherein the security credential comprises at least one of shared secrets stored in the first and second devices, and standard certificates.

22. A method as claimed in claim 15, wherein the connecting of the first and second devices occurs using the associated information, and wherein the connection between the first and second device bypasses the third party.

23. A method as claimed in claim 15, further comprising carrying out end to end authentication between the first and second devices.

24. A method as claimed in claim 15, further comprising:
exchanging information between the first and second device;
calculating at each of the first and second device a value using the information; and
comparing the values.

25. A system comprising:
a first device;
a second device; and
a third party,
wherein:
the first device is configured to obtain from said third party a temporary unique identifier;
the third party is configured to store said temporary unique identifier in association with information related to said first device;
the first device is configured to communicate said temporary unique identifier to a user;
the second device is configured to have an input to receive from said user said temporary unique identifier; and
the second device is configured to receive from said third party said information related to said user.

26. A first device, comprising:
a transmitter arranged to transmit information associated with said first device to a third party;
a receiver arranged to receive said temporary unique information from said third party;
a user interface arranged to provide said temporary unique information to a user; and
a processor configured to permit the establishment of a secure connection with a second device, on the basis of said temporary unique information, said first and second devices being connected to one another via at least one other entity.

27. A second device, comprising:
a user interface arranged so that a user can input temporary information associated with a first device to which said second device is to be connected;
a transmitter arranged to send said temporary unique information to a third party; and
a receiver arranged to receive from said third party information associated with said first device, said associated information permitting the second device to connect to said first device.

28. A third party, comprising:
a processor arranged to select a temporary unique identifier to be associated with a first device;
a memory arranged to store an association between said temporary unique identifier and information related to said first device;
a transmitter arranged to send said temporary unique identifier to said first device and said information related to said first device to said second device; and
a receiver arranged to receive said temporary unique identifier from said second device.

29. A computer program, embodied in a computer-readable medium, for use on a first device comprising computer readable program portions, comprising:
a first executable portion for causing information associated with said first device to be sent to a third party;
a second executable portion for receiving temporary unique information from said third party;
a third executable portion for causing said temporary unique information to be provided to a user; and
a fourth executable portion for causing a secure connection to be established with a second device, on the basis of said temporary unique information, said first and second devices being connected to one another via at least one other entity.

30. A computer program, embodied in a computer-readable medium, for use on a second device comprising computer readable program portions, comprising:
a first executable portion for receiving temporary unique information associated with a first device to which said second device is to be connected;
a second executable portion for causing said temporary unique information to be sent to a third party; and
a third executable portion configured to receive from said third party information associated with said first device, said associated information permitting the second device to connect to said first device.

31. A computer program, embodied in a computer-readable medium, for use on a third party comprising computer readable program portions, comprising:
a first executable portion for selecting a temporary unique identifier to be associated with a first device;
a second executable portion for causing an association between said temporary unique identifier and information related to said first device to be stored;
a third executable portion for causing said temporary unique identifier to be sent to said first device;
a fourth executable portion for receiving said temporary unique identifier from said second device; and
a fifth executable portion for causing said information related to said first device to said second device.
